(19) United States
(12) Patent Application Publication
(10) Pub. No.: US 2020/0245747 A1
(43) Pub. Date: Aug. 6, 2020

(54) Backpack With Electronic LED Structure

(71) Applicant: PIX Inc., Dover, DE (US)

(72) Inventors: Sergii Iezdin, Kyiv (UA); Marharyta Rimek, Kyiv (UA)

(73) Assignee: PIX Inc., Dover, DE (US)

(21) Appl. No.: 16/854,732

(22) Filed: Apr. 21, 2020

Related U.S. Application Data
(63) Continuation-in-part of application No. 16/145,177, filed on Sep. 28, 2018.

(51) Int. Cl. A45F 3/04; G09G 3/32

(52) U.S. Cl. CPC A45F 3/04; A45F 2003/003; G09G 3/32

(57) ABSTRACT

A backpack active element module in combination is provided having suspension support arrangement provided between at least top and bottom walls of a front backpack compartment and respective regions of the module. The suspension support arrangement acts as an active element/module shock absorber during movements of the user carrying the backpack. In this manner operation of the active element module is not affected by the shock developed during movements of the user.

### REFERENCE TO RELATED APPLICATION

This Application is continuation-in-part application of U.S. patent application Ser. No. 16/145,177 filed Sep. 28, 2018, the entire disclosure of which is hereby incorporated by reference.

### FIELD OF THE INVENTION

The present invention relates to backpacks in general, and more specifically the invention pertains to improved backpacks that include an electronic LED structure.

### BACKGROUND OF THE INVENTION

The are known backpacks with a built-In light indicator displays created for travelling, and also equiped with a blinking LED panel. Such arrangements allow others to see a person better while he or she is travelling or participating in sports, hiking or other outdoor activities. These arrangements can be used by cyclisys, runners, skateboarders, roller skaters and scooters.

One of the essentilal drawback of the above prior art backpacks is that the active element or LED structure is often not well protected and can be damaged when backpack falls or mishandled during the use and is unstable within the backpack structure. Prior art is practically silent as to how protect operation of the active element/module from shocks developed during movements of the user carrying the backpack.

Further, manufacturing backpack with active elements displays in general and incorporation of the active elemet into the backpak structure in particular is labor intensive, complicatted and cumbersam. The prior art is typically silent with respect how the active element should be protected from shocks and vibrations.

Therefore, it has been long felt and unsolved need for a backpak-active element combination, wherein the active element is well protected from damage and is stably positioned within and securely integrated with the backpack front compartment.

There is also a need for a backpack which is not affected by the shocks and impulse forces which are imparted on the active element during movements of the user, so to provide a design of the backpack-active element combination which is well protected during travel or physical activities of a user and in case of fall and other unpredictable circumstances.

Furthermore, it has been also a need for a method of formation a backpak-active element combination, which is simple and economical and can be produced without substantial burden on the manufacturer, so that the resulted backpak is afordable to the consumer without sucrifizing the quality of the technological features.

### SUMMARY OF THE INVENTION

One aspect of the invention provides a combination of a backpack and an active element generating an image visible to an outside viewer. The backpack consists of at least a front portion being visible from the rear when the backpack is worn, the front portion provided with a front compartment formed by front, rear and bottom walls interconnected by first and second side walls defining an operational space therebetween to receive an active element module.

The active element module consists of a front panel; a front protective pad; an intermediate panel, a rear protective pad and a rear padding layer; the front panel and the intermediate panel with the front protective pad positioned therebetween define a front protective arrangement/unit, the rear protective pad and the rear padding layer define a rear protective arrangement/unit; an active element including a plurality of video diodes LEDs and a control unit is interposed between the front and rear protective units.

Suspension support means is arranged at least between the top wall of the front compartment and a top region of the module which includes at least top regions of the front and rear protective arrangements and between the bottom wall of the front compartment and at least bottom regions of the front and rear protective arrangements, so that said suspension support means acts as an active element module shock absorber during movements of the user carrying the backpack. Operation of the active element module an alignment between the front and intermediate panels is not affected by shocks developed during movements of the user carrying the backpack.

As to another aspect of the invention, the suspension support means is also arranged between the side walls of the front compartment and side regions of the active element module.

As to a further aspect of the invention the suspension support means is a resilient web uniformly distributed relative to the active element module and the operational space of a front compartment interface.

As to another aspect of the invention, a central grid region of the front panel is defined by a plurality of spaced-apart longitudinal components, and a plurality of spaced apart lateral components, the longitudinal and lateral components intersect one another at nodes defining a repeating pattern of cells. A central grid region of the intermediate panel is defined by a plurality of spaced-apart longitudinal components, and a plurality of spaced apart lateral components, the longitudinal and lateral components intersect one another at nodes defining a repeating pattern of cells. The front panel and the intermediate panel are arranged, so that there is direct alignment between the respective cells. A front side of the active element is formed with a plurality of there are LED elements, wherein the light transmitted by each LED is isolated from the light of adjacent LEDs by a corresponding double aligned cells of the intermediate and front panels, so that there is no interference between the lights of adjacent LEDs, resulted in a quality image generated by the active element.

As to still further aspect of the invention the suspension arrangement prevents the direct alignment between the respective frames of said panels from shifting during the shocks developed during movements of the user carrying the backpack.

### BRIEF DESCRIPTION OF THE DRAWING

The invention will be described with respect to the following drawing figures, in which like numerals represent like features throughout the invention, and in which:

FIG. 1 is a semi-perspective view illustrating the active element module positioned in the backpack front compartment.

FIG. 2 is a front view of the module within the front compartment, having the front wall of the compartment being removed exposing the front grid panel.

FIG. 3 is a front view of a rear padding layer.

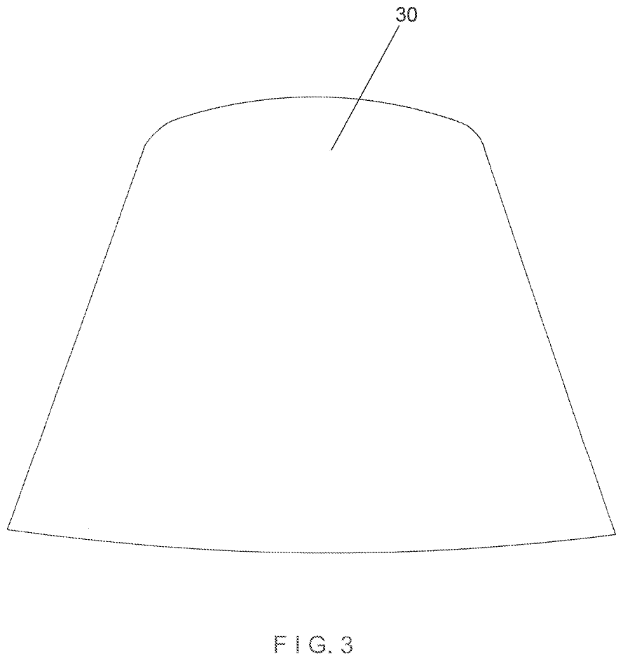

FIG. 4 illustrates front and rear protective pads.

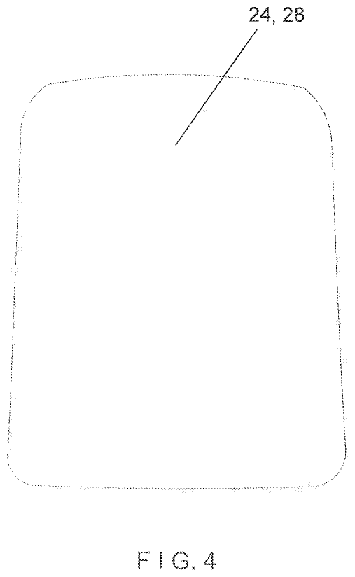

FIG. 5 is a front view of the active element.

FIG. 6 is a view of an intermediate grid panel.

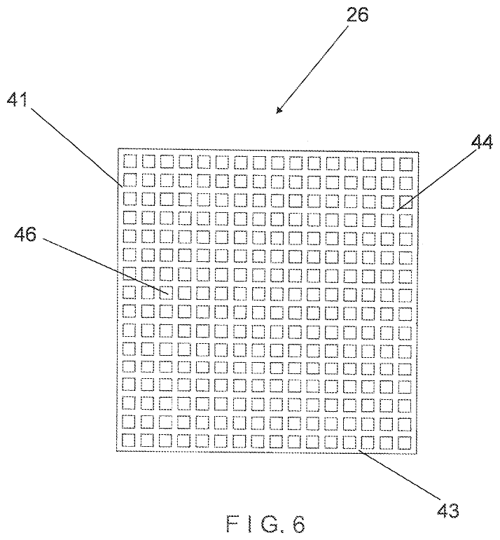

FIG. 7 is a view of the front grid panel.

FIG. 8 is an exploded view showing the elements of the active element module including the front and rear protective units.

FIG. 9 is a diagramatic exploaded view showing the elements of the active element module suspended within the backpack front compartment.

FIG. 10 is an exploded view showing another embodiment of the elements of the active element module.

FIG. 11 is a view of the control unit.

### DETAILED DESCRIPTION OF THE INVENTION

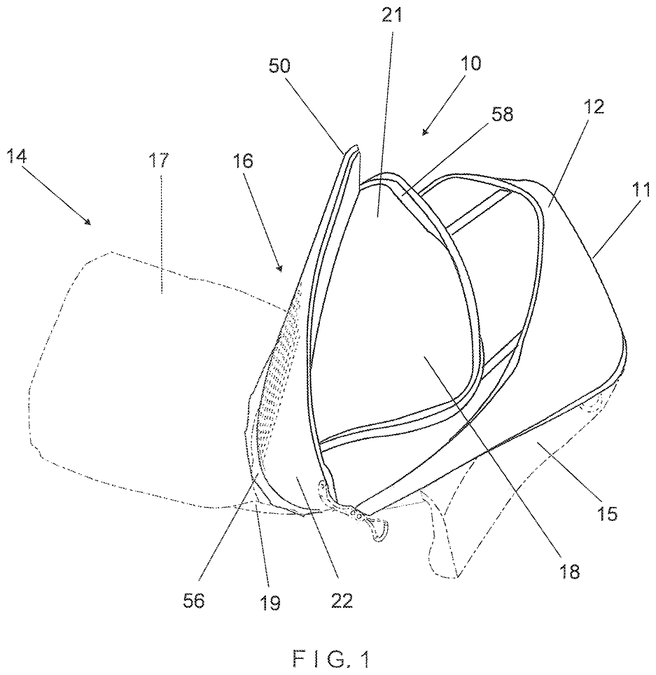

Referring now to FIG. 1 showing the backpack 10 which comprises a housing 12 forming an interior volume therein. The housing 12 includes a general opening that provides access to the interior volume, wherein the general opening includes a fastener that selectively opens and closes access to the interior volume. Preferably, the fastener is a zip fastener, however, other suitable types of fasteners are contemplated. It is contemplated that the shape of the housing 12 includes a variety of shapes and forms. The housing 12 further includes at least one strap 15 attached thereon configured to be wrapped around a user's shoulder to support the backpack 10. The backpack may be made of any suitable material such as various types of fabric including canvas, nylon, leather, and the like.

The backpack 10 has a back portion 11 and a front portion 14. The front portion Is visible from the rear when the backpack is being worn in the traditional manner. The front portion is formed with a front compartment 16 which is adapted to receive the active element module 50. The front compartment can be sealed or access to its inner space may be achieved by means of, for example, zippers in the well known manner.

The front compartment 16 is formed by front 17, rear 18 and bottom 19 walls interconnected by first and second side walls 20 defining an operational space 21 therebetween which accommodates/receives the active element screen module 50. The front wall 17 is typically made of a translusent material, so as to allow light and images generated by the active element to pass through and to be visible to outside viewers. It will be discussed in the application that in the preferred embodiment the module is permanently suspended within the the operational hollow space 21 of the front compartment. However, the module insertable into the front compartment in a snagly manner is within the scope of the invention.

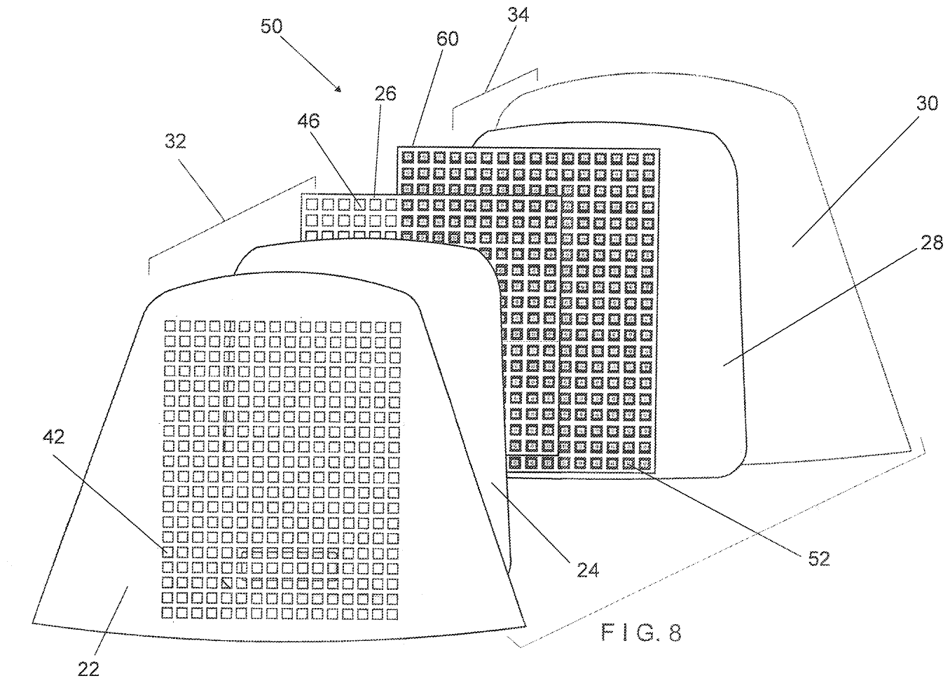

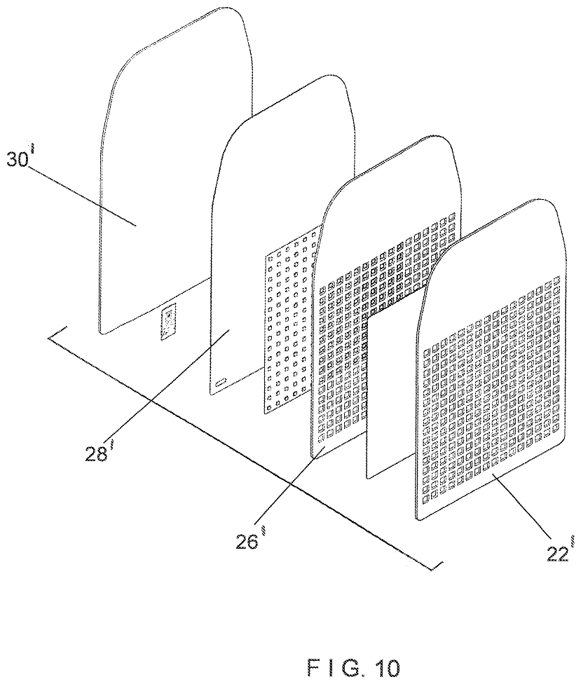

As best illustrated in at least FIGS. 8, 9 and 10 the active element module 60 comprises of the following essential elements: a front grid panel 22; a front protective pad 24; an intermediate grid panel 26, a rear protective pad 28 and a rear padding layer 30. The front grid panel 22, front protective pad 24 and the intermediate grid panel 26 define a front protective arrangement/unit 32. The rear protective pad 28 and the rear padding layer 30 define the rear protective arrangement 34. The active element panel 60, which includes a plurality of video diodes LED elements 52 on its front side and the control unit 68 associated with the rear side, is interposed between the front 32 and rear 34 protective arrangements. In the suspended/assembled condition the front grid panel 22 faces the front wall 17 and the rear padding layer 30 faces the rear wall 18 of the front compartment.

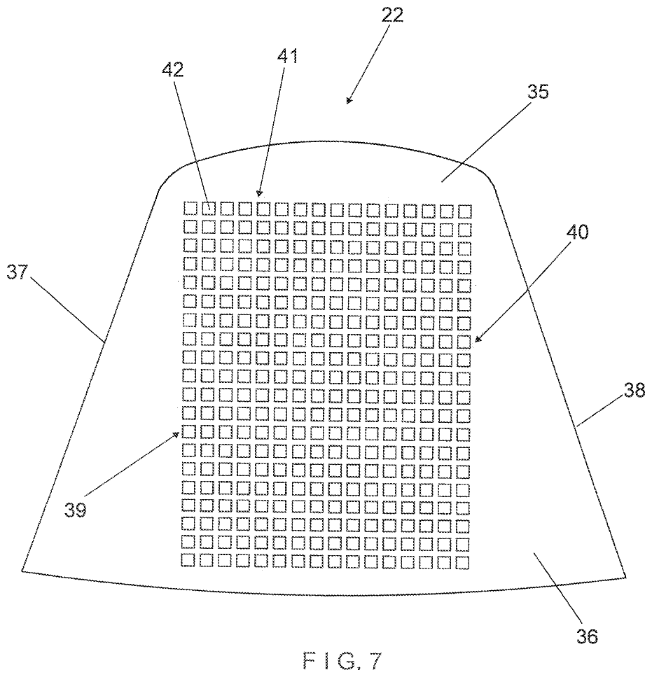

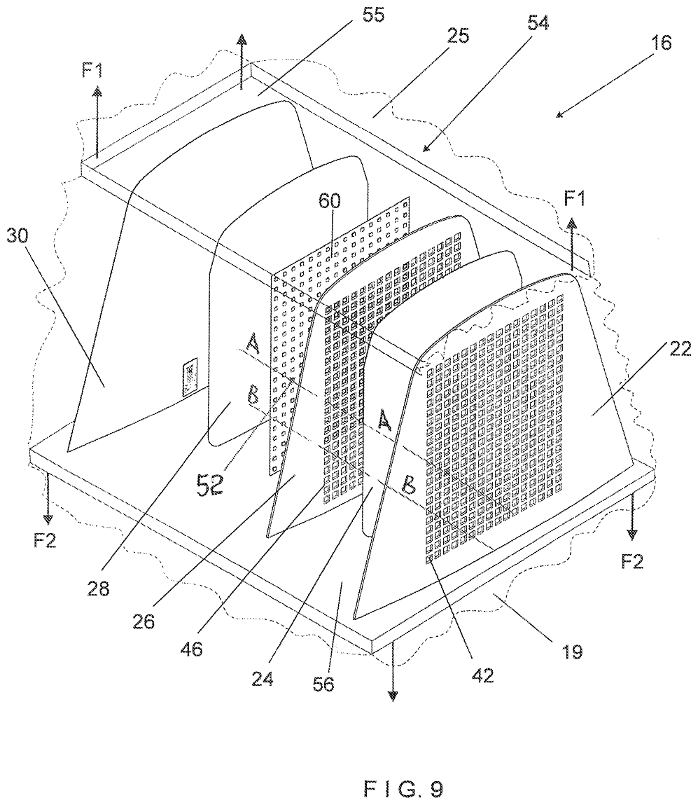

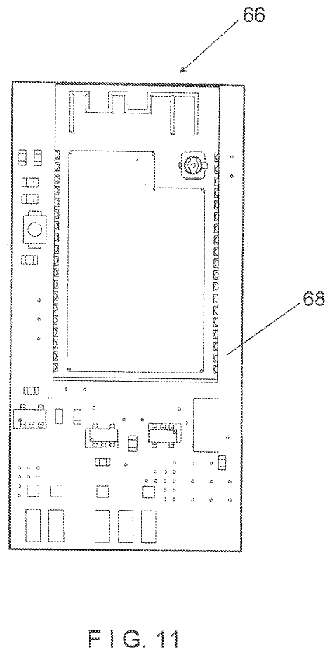

To fit better into the hollow operational space 21 of the front compartment, the front grid panel 22, and the rear padding layer 30 can be formed repeating a cross-sectional configuration of the operational space 21. In the illustrated embodiment this space has substantially trapezoidal configuration. As illustrated in FIG. 7, the front grid panel 22 is formed having top 35 and bottom 36 sides interconnected by first 37 and second 38 lateral sides, wherein the lateral sides are positioned at an acute angle to the bottom side. In the illustrated embodiment the top side 35 has an arc-shaped configuration. To provide even better stability additional elements, such as for example, the intermediate grid panel 26 can be also formed having a trapezoidal shape (see FIG. 9). Although the above-noted elements of the module having trapezoidal configuration are discussed with respect to the preferred embodiment, it should be noted that other shapes of the elements are within the scope of the invention. Essentially, the shape of the front 22 and rear 30 panels has to accommodate the operational space. For example, as illustrated in FIG. 11 to fit into the respective operational space the above-noted elements 22′, 26′, 28′ and 30′ are configured as parallelograms.

A central grid area of the front panel 22 is formed by a plurality of elongated and spaced-apart longitudinal components 39, and a plurality of elongated and spaced apart lateral components 41. The longitudinal components 41 have a similar orientation and are arrayed in a spaced-apart relationship. Similarly, the lateral components 41 have a similar orientation, and are arrayed in a spaced-apart relationship. The longitudinal components 39 and lateral components 41 have transverse orientations with respect to one another, such that the longitudinal and lateral components cross or intersect one another at nodes. The components are arranged in a repeating pattern along the front grid panel 22. The components are interconnected defining a repeating uniform pattern of openings or cells 42 therethrough. More specifically, the the interconnected elements define the repeating patern of openings or cells 42 having a uniform square or rectangle configuration, pixels. A self-adhesive layer can be provided on the inner surface facing the front panel 24.

The front panel 22 is typically made of a material which is resilient enough to perform a protective function but have enough rigidity to retain the predetermined rectangle configuration of the openings or cells 42. A resilient padding material can be used for making the front panel 22. A resilient foam plastic can be used for this purpose. A suitable example of the foam plastic is EVA or ISOLON foam which is flexible and resilient. The specific type and thickness of the material as well as the densities and degrees of resiliency may vary.

The resiliency of the front panel 22 serves a protective function. If the backpack is dropped on the ground or deformed, the foam front panel softens the blow and protects the active element screen, making the backpack-active element combination more impact resistant.

The front protective pad 24 is flexible, transparent and solid enough to perform a protective function. It can be made from a transparent plastic. A substantial level of transparency is needed for the protective pad 24 to transmit light from the LEDs through to the front panel 22 so as to be visible to a viewer looking the front compartment. An essential function of the protective pad 24 is to protect the active element not only from moisture and dust, but also to protect from damage.

In the invention the front 24 and rear 28 protective pads are bendable and can be stretchable without affecting the electronic functionality of the active element 60 disposed therebetween, so as to protect the active element from water or other damage. Thus, the electronics is not subjected to external shocks and protected against damage. The front protective pad 24 may additionally or alternatively provide for an anti-reflective surface.

In a manner similar to the above-discussed regarding the front panel 22, a central region of the intermediate panel 26 is defined by a plurality of elongated and spaced-apart longitudinal components 41, and a plurality of elongated and spaced apart lateral components 43 arrayed in a spaced-apart relationship. The longitudinal and lateral components cross or intersect one another at nodes. The components are interconnected defining the repeating pattern of openings or cells 46 throughout. The openings or cells 46 have a uniform square or rectangle configuration, pixels. In the formation of the front protective arrangement 32 the front panel 22 and the intermediate panel 26 are arranged (see FIG. 9), so as to provide direct alignment and correspondence between the respective cells 42,46 of both panels. Further, there is a direct correspondence and/or alignment between LEDs 52 of the active element and the cells 42, 46 of the front and intermediate panels. It is illustrated in FIG. 9 that in the formation of the module the front panel 22, the intermediate panel 26 and the active element panel 60 are aligned , so that the respective cells 42 of the front panel, the cells 46 of the intermediate panel and LEDs 52 are disposed along continuous longitudinal axes A-A and B-B for example.

In the invention light generated and transmitted by each LED element is isolated from the light of adjacent LED elements by the corresponding double aligned cells 42 and 46 of the intermediate and front panels. Thus, there is no interference between the lights of adjacent LED elements which makes the image generated by the active element 60 crisp and clear. The intermediate foam panel 26 also creates a protective space between the LED units of the active element 60 and front protective pad 24.

The intermediate panel 26 is typically made of a foam material which is resilient enough to protect electronics of the active element 60 from mechanical damage and vibration. The material should have enough rigidity to retain the predetermined configuration of the openings or cells 46. In a specific embodiment it can be made of polyurethane foam having layers of adhesive on both faces to facilitate connection to the adjacent elements. Use of other materials is within the scope of the invention.

As illustrated in FIG. 8 in the formation of the module 50, in the front direction the electronics of the active element panel 60 is protected by the front protective assembly 32 consisting of double padding layers of the front panel 26 and the intermediate panel 48 fortified by the front protective pad 24 interposed therebetween. In the rear direction the active element 60 is protected by a rear protective assembly 34 which includes a rear padding layer 30 fortified by the rear protected pad 28 facing the active element 60.

The rear padding layer 30 is a foam pad, which is typically made from a material similar to that of the front panel 22. The main function of the padding layer 30 is to protect the active element screen, so as to further enhance impact resistance of the backpack-active element combination of the invention. Further, since the rear padding layer 30 faces the rear wall of the front compartment, use of the resilient foam material makes the use of the backpack more user friendly.

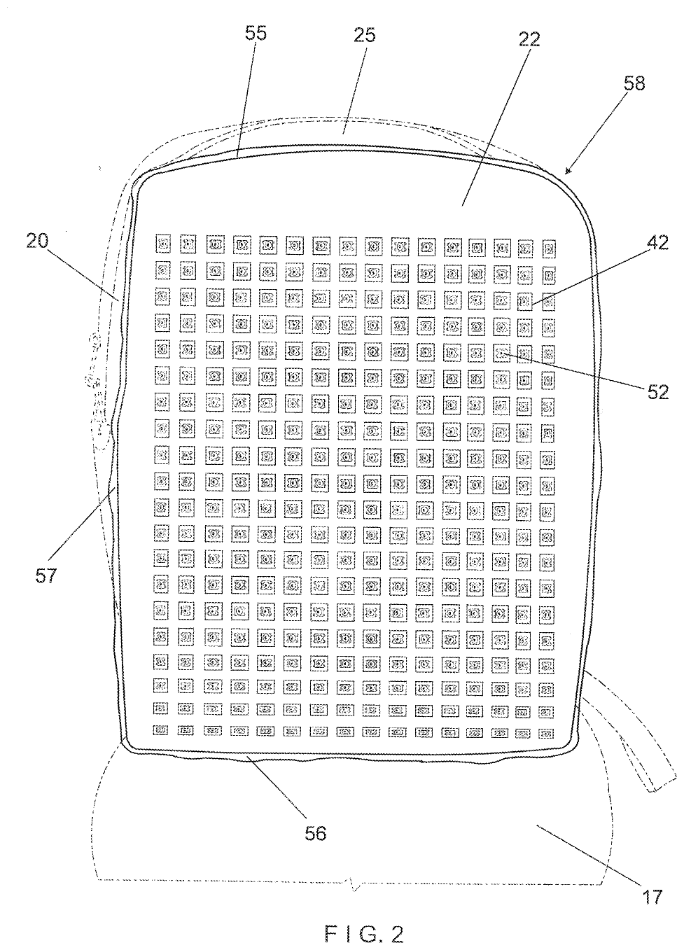

In the assembled condition the module 50 including the electronics of the active element 60 surrounded by and spaced between the front 32 and rear 34 protective arrangements are suspended within the operational space 21 of the backpack font compartment. As illustrated in FIGS. 1, 2, and 9 suspension support means 55 are arranged at least between the top wall 25 of the front compartment and the top region of the module 50, which includes at least top regions of the front 32 and rear 34 protective arrangements. Suspension support means 56 is provided between the bottom wall 19 of the front compartment and the bottom region of the protective arrangements 32 and 34. Alternately, as illustrated in FIG. 2, side suspension support means 57 are also arranged between the side walls 20 of the front compartment and the side regions of the module including the side regions of the front 32 and rear 34 protective arrangements. In the latter embodiment the entire module 60 is suspended within the operational opening of the front compartment. The suspension can be accomplished in various ways. As illustrated in FIGS. 1, 2 and 9 the suspension support means is a resilient web or an elastic strip 58 which is uniformly distributed relative to the module-inner compartment interface. More specifically, as illustrated in FIG. 9 a top suspension bridge 55 in the form of the resilient web extends from the top wall 25 of the front compartment surrounding the top region of the module. In a similar fashion a bottom suspension bridge 56 formed as the resilient web extends from the. bottom wall 19 of the front compartment surrounding the bottom region of the module. If in the course of movements of the user carrying the backpack, a shock is developed resulted in undesired external forces affecting the active element of the module, the oppositely directed stabilizing forces F1 and F2 are generated by the suspension bridges 55 and 56. The forces F1 and F2 stabilize the module within the inner compartment to minimize the shocks to the electronics of the active element 60. Due to the resiliency of the suspension bridges 55, 56 this design acts as an active element-module shock absorber. This design also has the advantage of improving the damping the disturbing forces at the module by using the suspension means webs having enhanced elastic properties. Side suspension arrangements/bridges 57 operate as shock absorbers in the horizontal direction.

The active element 60 may be configured to display one or more colors, designs, images, series of images, videos, and/or other elements, and may be configured to display a dynamic display. In the illustrated embodiment the active element 60 forms a part of the module positioned within or incorporated into the interior operational space 21 of the front compartment, such that the generated light and or images are visible to outside observers while the backpack is positioned on a user's back. In the preferred embodiment, as discussed in the application the active element 60 is configured having rectangular shape. On the other hand, the active element 60 may generally have any suitable shape. For example, the active element 60 may have round, triangular, or generally any other shape.

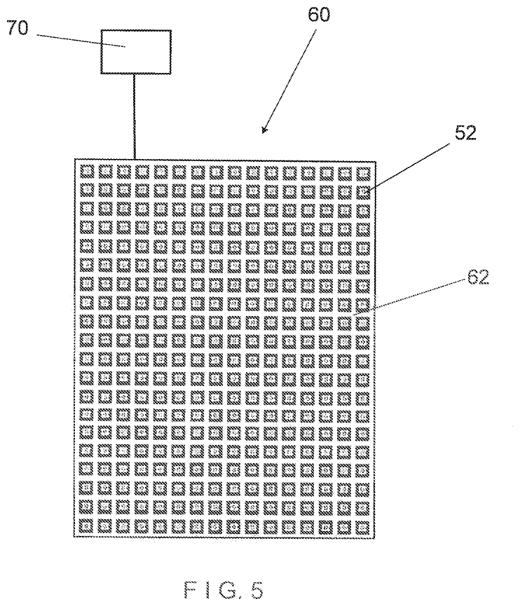

The display unit 62 of the active element is implemented by using a plurality of light-emitting diodes formed in a printed circuit board or using any one of a plurality of light-emitting diodes, conductive yarns, and a combination of fibers. As can be seen in FIGS. 5, 8, 9 and 10 the LEDs 52 are arranged in rows and columns which corresponds to the opening or cells 42 and 46 in the central regions of the front 22 and intermediate 26 grid panels. Generated images are visually seen externally.

In the illustrated embodiment the active element is a display screen which includes one or more displays such as an LED structure. It is controlled by the controller 66 using software integrated with the electronic LED structure by wireless communication. The control board 68 can be located at any part of the backpack. The power source may be a smartphone, tablet, computer, or any other device having software and able to support wireless data communication. In the illustrated embodiment the electrinic LED structure is in the form of a a flexible LED panel. However, the LED structure can be solid board or LED tape, or other form of interconnected diodes. According to the system of the invention if a customer choses an appropriate image at the smartphone by special application, this image will be automatically shown at the LED structure through a wireless connection. It also can be removed by above-mentioned application.

Power supply 70 may be in the form of a Power Bank or any other other compact power source. For example, the power supply 70 may include one or more batteries or energy storing devices. The batteries may be rechargeable. A circuit may provided to include means for charging the power supply 70. For example, the circuit may include a USB, micro USB, or other port for connecting a power source to charge the power supply 70. In other embodiments, the power supply 70 may be charged by other means, including remote or wireless charging means.

In the invention application software may be provided allowing a user to download designs from a source of designs provided by the software or from third parties for display on the active element. The application software may be available as an app for a smartphone or tablet, for example. The app may allow the user to select from a variety of designs and the app may be configured to communicate with and to adjust, program, or otherwise control the active element 60.

The active element 60 may be configured to display various types of images which may be operably selected by a user. For example, the active element may display a color, pattern, photograph, custom image, or other image or series of images, or a video. The active element 60 may display dynamic images.

In some embodiments, application software, such as a smartphone application for example, may be used to download or upload colors, images, videos, or other media to the modifiable displays. The application may further allow users to control other properties of the modifiable display, such as timing or other functions. In some embodiments, the application may allow users to create or customize images, videos, or other media for modifiable displays. Additionally, or alternatively, the application may allow users to download or purchase images, videos, or other media to send to the modifiable displays.

In the initial step of the method of the invention, the front grid panel 22, front protective pad 24 and the intermediate grid panel 26 are assembled to form a front protective arrangement/unit 32. In this step the front protective pad 24 made of transparent plastic is positioned at a rear side of the front grid panel 22 to face the intermediate grid panel 26. Then, the intermediate grid panel 26 is attached to the front protective pad 24, so that the cells of front grid panel 22 and the intermediate grid panel 26 are arranged in the above-discussed manner to exactly face each other in the complete correspondence to each other. Then, the active element panel 60 is positioned, so that the video diodes LED 52 face and to be aligned with the cells 46 of the intermediate grid panel 26 in the above-discussed manner. The rear protective arrangement 34 is formed by combining the ear protective pad 28 and the rear padding layer 30. Then, the rear protective arrangement 32 is connected to a rear side of the active element panel 60. In the assembled condition the front grid panel 22 faces the front wall 17 and the rear padding layer 30 faces the rear wall 18 of the front compartment. Then, the formed module 50 is connected to the backpack inner compartment. Although various ways of combining the elements of the module are contemplated, in one embodiment the resilient webs 58 of the suspension arrangement is used for this purpose.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It should be clear from the above that the invention provides a backpak-active element combination, with the active element being stably positioned within and securely integrated with the front compartment. In this manner the active element is not shifted during travel or physical activities. The present invention also provides a method of forming a backpak-active element combination, which is simple and economical and can be produced without substantial burden on the manufacturer. Thus the backpak is afordable to the consumer and can be used without sucrifizing the quality of the technological features discussed in the application.

What is claimed is:

1. A backpack and an active element generating an image visible to an outside viewer in combination comprising:
the backpack comprising at least a front portion being visible from the rear when the backpack is worn, the front portion provided with a front compartment formed by front, rear and bottom walls interconnected by first and second side walls defining an operational space therebetween to receive an active element module;
the active element module comprising a front panel; a front protective pad; an intermediate panel, a rear protective pad and a rear padding layer; the front panel and the intermediate panel with the front protective pad positioned therebetween define a front protective arrangement/unit, the rear protective pad and the rear padding layer define a rear protective arrangement/unit; an active element including a plurality of video diodes LEDs and a control unit is interposed between the front and rear protective arrangements/units;
suspension support means arranged at least between the top wall of the front compartment and a top region of the module which includes at least top regions of the front and rear protective arrangements and between the bottom wall of the front compartment and at least bottom regions of the front and rear protective arrangements, so that said suspension support means acts as an active element module shock absorber during movements of the user carrying the backpack;
wherein operation of the active element module an alignment between the front and intermediate panels is not affected by shocks developed during movements of the user carrying the backpack.

2. A backpack active element module in combination of claim 1, wherein the suspension support means is also arranged between the side walls of the front compartment and side regions of the active element module.

3. A backpack active element module in combination of claim 2, wherein the suspension support means is a resilient web uniformly distributed relative to the active element module and the operational space of a front compartment interface.

4. A backpack active element module in combination of claim 1, further comprising a central grid region of the front panel defined by a plurality of spaced-apart longitudinal components, and a plurality of spaced apart lateral components, the longitudinal and lateral components intersect one another at nodes defining a repeating pattern of cells;
a central grid region of the intermediate panel defined by a plurality of spaced-apart longitudinal components, and a plurality of spaced apart lateral components, the longitudinal and lateral components intersect one another at nodes defining a repeating pattern of cells; and
the front panel and the intermediate panel are arranged, so that there is direct alignment between the respective cells.

5. A backpack active element module in combination of claim 4, further comprising a front side of the active element is formed with a plurality of LED elements, the front panel, the intermediate panel and the active element are arranged, so that there is direct alignment between LED elements of the active element and the cells of the front and intermediate panels, wherein light transmitted by each said LED element is isolated from the light of adjacent LED elements by a corresponding double alligned cells of the intermediate and front panels, so that there is no interference between the lights of adjacent LEDs, resulted in a quality image generated by the acvtive element.

6. A backpack active element module in combination of claim 5, wherein during formation of the module the front panel, the intermediate panel and the active element panel are aligned, so that the respect cells of the front panel, the cells of the intermediate panel and LED elements are disposed along continuous longitudinal axis.

7. A backpack active element module in combination of claim 4, wherein the cells of the front and intermediate panels are formed having a uniform rectangle shaped configuration.

8. A backpack active element module in combination of claim 5, wherein said suspension arragement prevents the direct alignment between the respective cells of said panels from shifting during the shocks developed in the course of movements of the user carrying the backpack.

9. A backpack active element module in combination of claim 1, further comprising an electronic LED structure controlled via the control board by the control device via software integrated with the electronic LED structure by the wireless communication and an electronic power supply.

10. A backpack active element module in combination of claim 9, wherein said control device is selected from the group including a smartphone, tablet, computer and/or other devices for which a software can be installed and which supports wireless data exchange.

11. A backpack active element module in combination of claim 10, wherein the electronic LED structure is selected from the group including an LED panel, a flexible or solid board, an LED strip, or other forms of interconnected diodes.

12. A backpack active element module in combination of claim 10, wherein the control board maintains the wireless data exchange, and power supply may be a Power Bank or other compact power sources.
